(19) United States
(12) Patent Application Publication
(10) Pub. No.: US 2026/0127444 A1
(43) Pub. Date: May 7, 2026

(54) NETWORK TRAINING, AND ASSOCIATED NETWORKS, MODELS, SYSTEMS, DEVICES, METHODS, AND COMPUTER-READABLE MEDIA

(71) Applicant: LiveView Technologies, LLC, American Fork, UT (US)

(72) Inventor: Weijun Tan, American Fork, UT (US)

(21) Appl. No.: 18/938,094

(22) Filed: Nov. 5, 2024

(51) Int. Cl. G06N 3/098

(52) U.S. Cl. CPC G06N 3/098

(57) ABSTRACT

Various embodiments relate to network training, and associated systems and non-transitory computer-readable media. In some embodiments, a system may include a classifier configured to receive a first dataset and a second dataset. The classifier may include a backbone having a number of layers and configured to generate an output based on at least one of the first dataset or the second dataset. The system further includes a first classification head configured to receive the output of the backbone and generate a first loss function. The system also includes a second classification head configured to receive the output of the backbone and to generate a second loss function.

### TECHNICAL FIELD

This disclosure relates generally to network training. More specifically, this disclosure relates to training of multi-head neural networks with a number of datasets, and to related networks, models, systems, devices, methods, and computer-readable media.

### BACKGROUND

Improved processing power, better algorithms, and the availability of big data are facilitating the implementation of machine learning functionality into a variety of different applications. Machine learning is an enabling technology for the revolution currently underway in artificial intelligence, driving advances in fields such as object detection, image classification, speech recognition, natural language processing, and many more.

Machine learning models receive an input and generate an output (e.g., a predicted output), based on the received input. Some machine learning models are deep models that employ multiple layers to generate an output for a received input. For example, a deep neural network is a deep machine learning model that includes an output layer and one or more hidden layers that each apply a non-linear transformation to a received input to generate an output.

### BRIEF DESCRIPTION OF THE DRAWINGS

FIG. 1A depicts two networks, each of which is configured for receiving an input and generating a predictive output.

FIG. 1B depicts an example network including a feature extraction phase and a classification phase, according to various embodiments of the disclosure.

FIG. 2 depicts an example system including a model and a classifier, in accordance with various embodiments of the disclosure.

FIG. 3 illustrates an example classifier, according to various embodiments of the disclosure.

FIG. 4 depicts an example classifier for receiving multiple datasets, according to various embodiments of the disclosure.

FIG. 5 illustrates an example classifier, according to various embodiments of the disclosure.

FIG. 6 depicts an example classifier including a personal attribute recognition classification head, in accordance with various embodiments of the disclosure.

FIG. 7 depicts an example classifier including a personal protection equipment classification head, in accordance with various embodiments of the disclosure.

FIG. 8 illustrates an example system including a classifier and a post processor, according to various embodiments of the disclosure.

FIG. 9 is another illustration of a system including a classifier and a post processor, according to various embodiments of the disclosure.

FIG. 10 is a flowchart of an example method of training a network, according to various embodiments of the disclosure.

FIG. 11 depicts an example system including a unit, in accordance with various embodiments of the disclosure.

FIG. 12 depicts another example system including a mobile unit, in accordance with various embodiments of the disclosure.

FIG. 13 illustrates another example system, according to one or more embodiments of the disclosure.

### DETAILED DESCRIPTION

Referring in general to the accompanying drawings, various embodiments of the disclosure are illustrated to show example embodiments related to network training and associated networks including classifiers. It should be understood that the drawings presented are not meant to be illustrative of actual views of any particular portion of an actual circuit, device, system, or structure, but are merely representations that are employed to more clearly depict various embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Various embodiments of the disclosure relate to networks including classifiers, and associated training methods. More specifically, various embodiments relate to classifiers of a network including one or more classification heads, and associated training thereof via the use of multiple (e.g., two) datasets. It is noted that each of the terms “network” and “classifier” may also include and/or be referred to as a “model” or a “system.” Embodiments of the disclosure will now be explained with reference to the accompanying drawings.

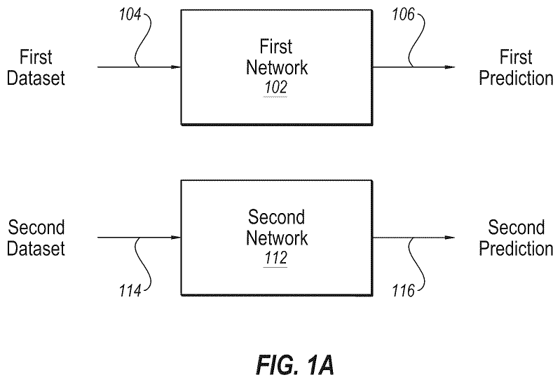

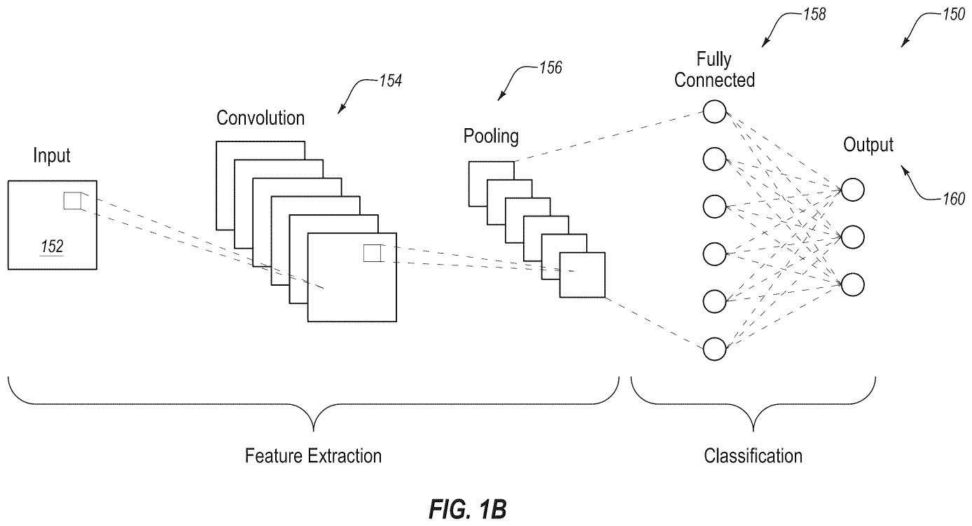

Conventional machine learning neural networks may be trained via a single dataset. For example, FIG. 1A depicts two networks, each of which receiving an input and generating a predictive output. More specifically, FIG. 1A depicts a first network 102 for receiving a first dataset 104 and generating a first prediction output 106, and a second network 112 for receiving a second dataset 114 and generating a second prediction output 116. For example, first network 102 may include a personal attribute recognition (PAR) network, first dataset 104 may include a PAR dataset, second network 112 may include a personal protection equipment (PPE) network, and second dataset 114 may include a PPE dataset.

FIG. 1B is a more detailed illustration of a network 150 including a feature extraction phase and a classification phase. The feature extraction phase of network 150 includes an input 152, convolution layers 154, and pooling layers 156. Further, the classification phase of network 150 includes fully connected layer 158 and output nodes 160. As will be appreciated, a fully connected layer refers to a neural network in which each neuron applies a linear transformation to an input vector through a weights matrix. As a result, all possible connections layer-to-layer are present, meaning every input of the input vector influences every output of the output vector.

As will be appreciated, in one example, input 152 may include a single cropped image including a detected object (e.g., an image including a bounding box around a person, an animal, or a vehicle). Further, convolution layers 154 may apply a convolution operation to input 152 and provide a data result to pooling layers 156, which may aggregate the data result (e.g., to reduce the dimensionality of input, thus controlling overfitting, improving computation efficiency, and extracting dominant features by aggregating nearby inputs). Further, as will be appreciated, fully connected layer 158 receives data from pooling layers 156 and transitions the data from feature maps to output 160, which may include an output prediction.

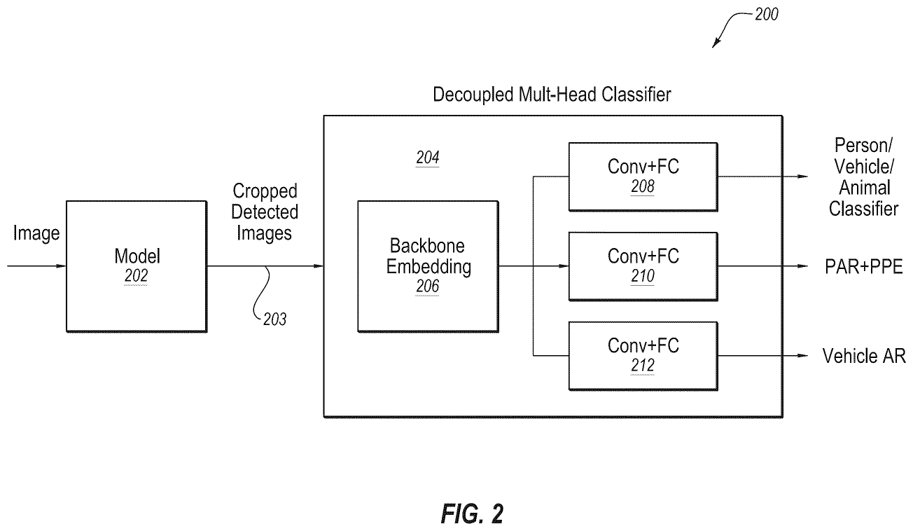

FIG. 2 depicts an example system 200, in accordance with various embodiments of the disclosure. System 200 includes a model 202 and a classifier 204, which may be referred to herein as a “decoupled multi-head classifier.” For example, model 202, which may include a vision model (e.g., YOLOv8 model), may detect an object (e.g., in a received image) and provide an input 203 (e.g., a cropped image including a detected object) to classifier 204.

Classifier 204 includes a backbone (also referred to as a “backbone embedding”) 206 and classification heads including a classification head 208, a classification head 210, and a classification head 212. Backbone 206 may encode input 203 into a certain feature representation, as will be appreciated by a person having ordinary skill in the art. In other words, backbone 206, which includes a number of convolution and/or pooling layers, may extract and encode features from input 203 (e.g., capture low-level and high-level features from input 203).

According to one non-limiting example, classification head 208 may include a person/vehicle/animal classifier (e.g., for generating a prediction regarding a person/vehicle/animal), classification head 210 may include a PAR and PPE classifier (e.g., for generating a prediction regarding a PAR and/or a PPE attribute), and classification head 212 may include a vehicle attribute recognition classifier (e.g., for generating a prediction regarding a vehicle).

In one example, wherein input 203 includes at least one detected object (e.g., a person, a vehicle, and/or an animal), each of classification head 208, classification head 210, and classification head 212 receives the same input (e.g., feature extraction) from backbone 206 and generates an associated output prediction. In another example, wherein input 203 includes at least one person, classification head 208 and/or classifier head 212 may not exist, or the outputs of classification head 208 and/or classification head 212 may be ignored. In this example, classification head 210 receives an input from backbone 206 and generates an associated output prediction.

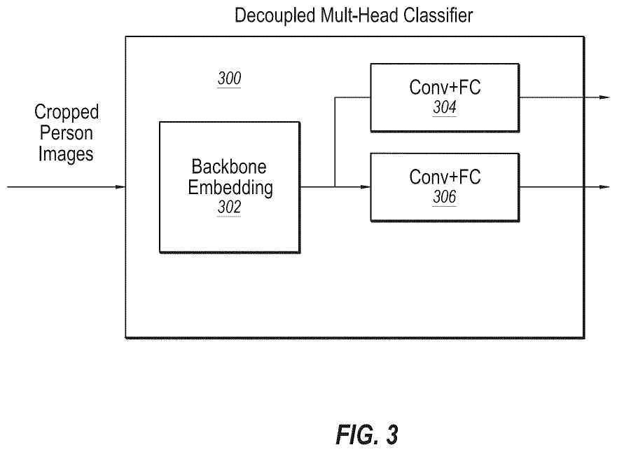

FIG. 3 illustrates an example classifier 300, according to various embodiments of the disclosure. Classifier 300, which includes a decoupled multi-head classifier, includes a backbone 302, a classification head 304, and a classification head 306. For example, classification head 304 may include a PAR classification head and classification head 306 may include a PPE classification head.

In this example, an output of classification head 304 may include predictions for a number of PAR attributes (e.g., gender, hair color, backpack, hat, upper body clothing color, lower body clothing color, etc.). More specifically, for example, the output of classification head 304 may include predictions for twenty-one (21) PAR attributes. Continuing with this example, an output of classification head 306 may include predictions for a number of PPE attributes (e.g., helmet, vest, and/or other protection devices (e.g., eye, face, ear, hand, foot protection devices)).

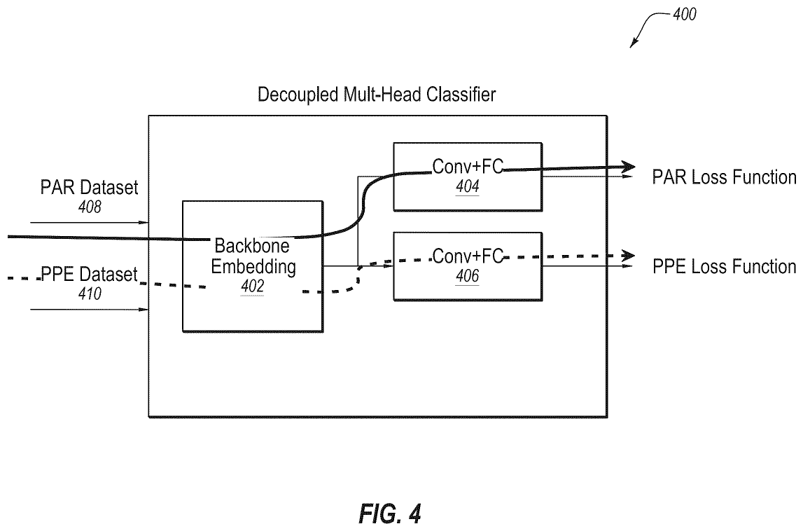

FIG. 4 depicts an example classifier 400 for receiving multiple datasets, according to various embodiments of the disclosure. Classifier 400, which may include classifier 300 of FIG. 3, includes a backbone 402, a first classification head 404, and a second classification head 406. Classifier 400 may be configured to receive a dataset (e.g., a PAR dataset) 408 and a dataset (e.g., a PPE dataset) 410.

For example, training of a network (e.g., including a classifier) may be performed with (e.g., using) two separate datasets, which may reduce a workload in contrast to conventional training methods that use a single dataset. More specifically, in contrast to conventional methods that require PPE annotations to be added to PAR datasets and/or require PAR annotations to be added to PPE datasets, various embodiments may train using two separate datasets (e.g., a PAR dataset and a PPE dataset).

With reference to FIG. 4, a contemplated and example method of training classifier 400, according to various embodiments, will now be described. A batch of dataset 408 may be received at backbone 402, which generates and provides an associated feature representation to classification head 404 and classification head 406. Moreover, classification head 404 and classification head 406 may each generate a loss function (e.g., indicative of how well classifier 400 is performing a task by comparing a predicted output to an actual target value). Further, for example, the loss function generated via classification head 404 may be used to train backbone 402 and classification head 404. Moreover, in some examples, the loss function generated via classification head 406 may be ignored.

Further, a batch of dataset 410 may be received at backbone 402, which generates and provides an associated feature representation to classification head 404 and classification head 406. Moreover, classification head 404 and classification head 406 may each generate a loss function. Further, for example, the loss function generated via classification head 406 may be used to train backbone 402 and classification head 406. Further, in some examples, the loss function generated via classification head 404 may be ignored.

In conventional machine learning training, a loss function may be used to generate a gradient, which may be back propagated (e.g., through a network) to update network parameters (e.g., weights and/or biases). According to various embodiments, when a dataset is PAR dataset 408, the PAR loss function (e.g., generated via classification head 404) may be used to update backbone 402 and classification head 404. Similarly, when a dataset is PPE dataset 410, the PPE loss function (e.g., generated via classification head 406) may be used to update backbone 402 and classification head 406. The batch (i.e., from dataset 408 or dataset 410) may vary (e.g., take turns) depending on, for example only, how many data points in each dataset.

According to various embodiments, training of classification heads (e.g., a PAR classification head and a PPE classification head) may occur substantially simultaneously (i.e., the classification heads may be trained jointly) or separately (e.g., alternatively). For example, a PAR training phase and a PPE training phase may occur substantially simultaneously. In another example, a PAR training phase and a PPE training phase may occur separately (i.e., in time). In some examples, a training schedule may be at least partially based on how much data (i.e., in each dataset) is available. In some embodiments, an amount of training for each classification head may be balanced. Stated another way, in some embodiments, the amount of effective data used to train a first classification head may be about equal to the amount of effective data used to train a second classification head. In one non-limiting example, if a PAR dataset is 10× larger than a PPE dataset, ten (10) batches of the PPE dataset may be used (i.e., for training) for every one (1) batch of the PAR dataset used (i.e., for training). Or, in another example, if a PAR dataset is 10× larger than a PPE dataset, ten (10) batches of the PAR dataset may be used (i.e., for training) for every one (1) batch of the PPE dataset used (i.e., for training).

In some examples, the balance of training of the two heads may not be necessary (e.g., a round-robin approach may be fine). When a dataset (e.g., the smaller dataset) is running out of data in a batch, it may simply wind back to the beginning of the dataset.

In one example, during one training phase (e.g., a PAR training phase), a batch of dataset 408 may be provided to backbone 402, and an output of backbone 402 may be received at both classification head 404 and classification head 406. Further, each of classification head 404 and classification head 406 may calculate a loss function. Further, during the PAR training phase, the output of classification head (e.g., a calculated PPE loss function) 406 may be ignored and the output of classification head (e.g., a calculated PAR loss function) 404 may be used to train backbone 402 and classification head 404. Further, during another training phase (e.g., a PPE training phase), a batch of dataset 410 may be provided to backbone 402, and an output of backbone 402 may be received at both classification head 404 and classification head 406. Further, each of classification head 404 and classification head 406 may calculate a loss function. Further, during the PPE training phase the output of classification head (e.g., a PAR loss function) 404 may be ignored and the output of classification head (e.g., a PPE loss function) 406 may be used to train backbone 402 and classification head 406.

In another example, during training, batches of dataset 408 and dataset 410 may be provided to backbone 402, and an output of backbone 402 may be received at both classification head 404 and classification head 406. Further, each of classification head 404 and classification head 406 may calculate an associated loss function, and the output of classification head (e.g., a calculated PAR loss function) 404 may be used to train backbone 402 and classification head 404, and the output of classification head (e.g., a PPE loss function) 406 may be used to train backbone 402 and classification head 406.

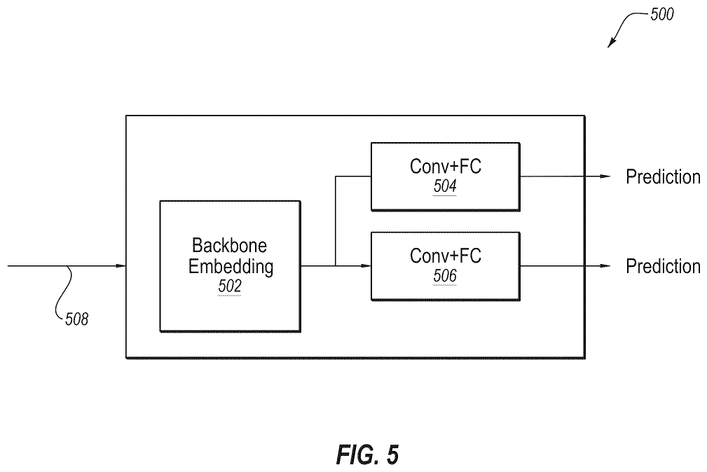

In some embodiments, a deployed classifier (e.g., for inference) may include multiple classification heads. FIG. 5 illustrates an example classifier 500, according to various embodiments of the disclosure. For example, classifier 500, which may be deployed (i.e., for use), includes a backbone 502, a classification head 504, and a classification head 506. During a contemplated use (e.g., after classifier 500 has been trained), an input (e.g., a cropped image including a person (i.e., not a dataset for training)) 508 may be received, backbone 502 may perform feature extraction, classification head 504 may generate a prediction (e.g., a PAR prediction) (i.e., based on extracted features), and classification head 506 may generate a prediction (e.g., a PPE prediction) (i.e., based on extracted features). It is noted that during inference, classification head 504 and classification head 506 may operate at substantially the same time (e.g., each head may generate an output substantially simultaneously).

In other embodiments, a deployed classifier (e.g., for inference) may include one classification head. In other words, for example, either a PAR classification head or a PPE classification head may be removed from a classifier prior to deploying the classifier.

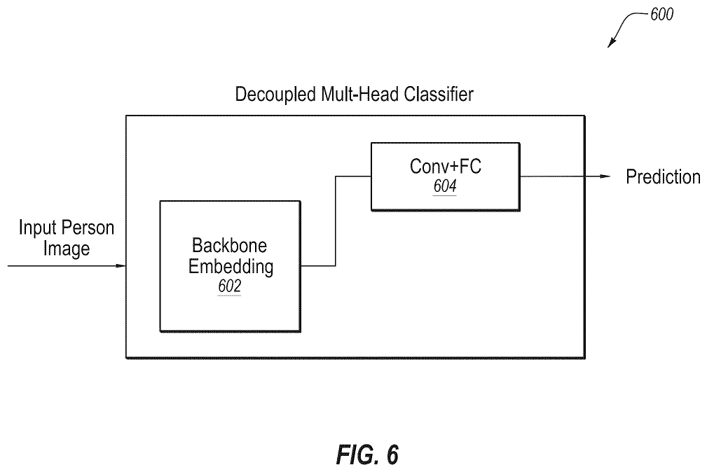

FIG. 6 illustrates an example classifier 600, according to various embodiments of the disclosure. Classifier 600, which includes a backbone 602 and a classification head 604, is configured to generate a PAR prediction. As noted above, in some scenarios, a PPE classification head may have been removed (e.g., at or prior to deployment), and parameters for backbone 602 and PAR classification head 604 may be loaded and utilized (e.g., for use of classifier 600).

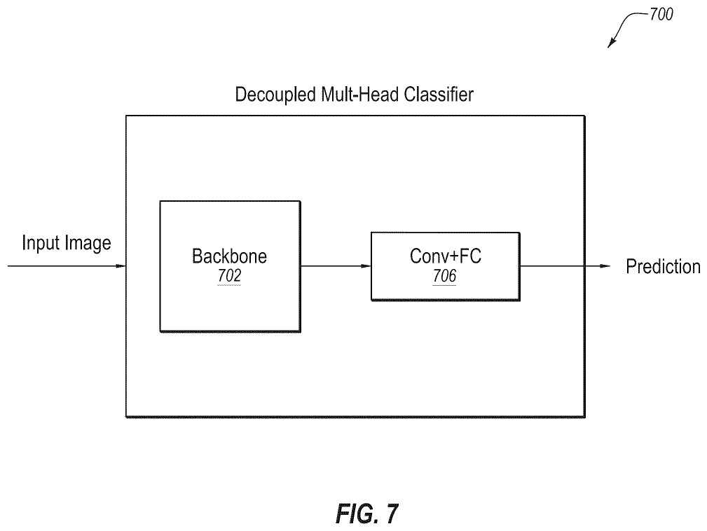

FIG. 7 illustrates an example classifier 700, according to various embodiments of the disclosure. Classifier 700, which includes a backbone 702 and a classification head 704, is configured to generate a PPE prediction. As noted above, in some scenarios, a PAR classification head may have been removed (e.g., at or prior to deployment), and parameters for backbone 702 and PPE classification head 706 may be loaded and utilized (e.g., for use of classifier 700).

In another example scenario, two or more datasets may have overlapping classes, and one or both of the datasets may be incomplete. In this example, as will be appreciated, it may take a substantial amount of time and/or work to reannotate one or more datasets. For example, a first data set may include 0, 1, 2, . . . , n classes (e.g., from one year, such as 2023). Further, it may be desirable to add another, related dataset (e.g., from another year, such as 2024) including classes n+1, n+2, . . . , n+k. As will be appreciated, it may be time-consuming and/or costly to reannotate the first dataset.

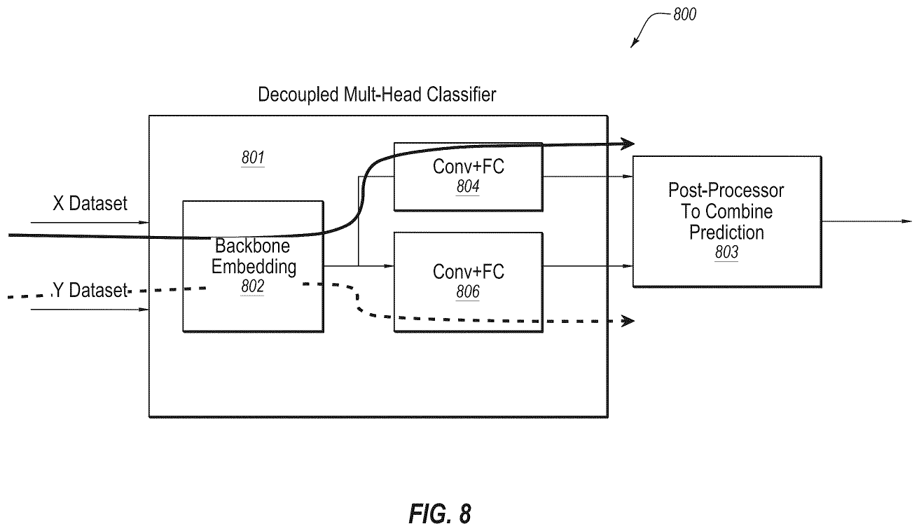

FIG. 8 depicts an example system 800, according to various embodiments of the disclosure. System 800 includes a classifier 801 and a processor 803. Classifier 801, which is configured for receiving a first dataset (X dataset) and a second dataset (Y dataset), includes a backbone 802, a first classification head 804, and a second classification head 806. Classifier 801 may also be referred to herein as a “decoupled multi-head classifier.” Processor 803 may be coupled to one or more outputs of classifier 801. A contemplated operation for training a plurality of classification heads with different, but possibly related (e.g., overlapping), datasets, will now be described with reference to FIG. 8.

For example, both X and Y datasets, as shown in FIG. 8, may include PAR datasets, or both X and Y datasets may include PPE datasets. In one example, Y dataset may be a superset of X dataset (i.e., Y dataset includes each attribute of X dataset and possibly more attributes). In another example, neither Y dataset nor X dataset is a superset of the other (i.e., the two datasets have unique attributes). In this example, X dataset may be received at classifier 801, and as described herein, backbone 802 and classification head 804 may be trained based on a loss function on dataset X generated by classification head 804. Further (e.g., subsequently), Y dataset may be received at classifier 801, and as described herein, backbone 802 and classification head 806 may be trained based on a loss function on dataset Y generated classification head 806.

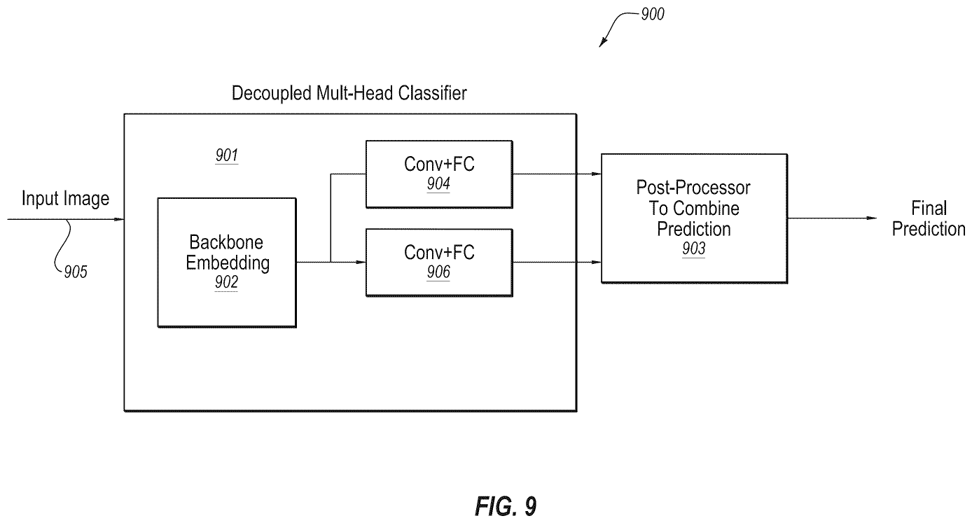

FIG. 9 depicts an example system 900 including a classifier 901 and a processor 903, in accordance with various embodiments of the disclosure. Classifier 901, which may include classifier 801 of FIG. 8, may be deployed (e.g., for inference). Responsive to receipt of an input (e.g., a cropped image including a person) 905, a backbone 902 may perform feature extraction, classification head 904 may generate a prediction (i.e., based on extracted features), and classification head 906 may generate another prediction (i.e., based on extracted features). Further, processor 903 may combine the predications of classification head 904 and classification head 906 to generate a prediction (“final prediction”).

If, for example, neither Y dataset nor X dataset is a superset of the other (i.e., the two datasets have unique attributes), both classification head 904 and classification head 906 may be used for inference, and processor 903 may be used to combine output predictions of each of classification head 904 and classification head 906 to generate a combined prediction. On the other hand, if, for example, Y dataset is a superset of X dataset, it may not be required to use classification head 904 during inference (e.g., classification head 906 may be sufficient), and, in this specific example, an output of classification head 906 may generate a final prediction (e.g., without a need for a processor to combine predictions to generate a prediction).

It is noted that in various embodiments, convolution in a classification head may be optional. In one example, if convolution is used, a feature from a backbone may not be pooled. In another example, if convolution is not used, a feature may be pooled.

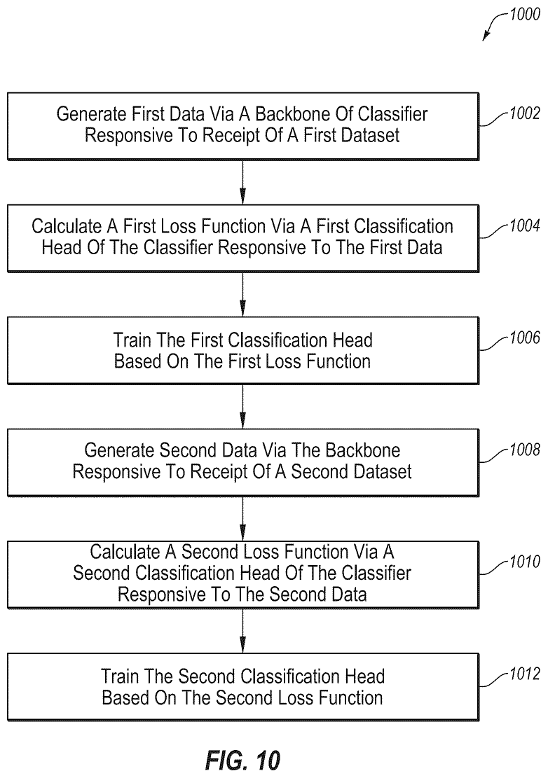

FIG. 10 is a flowchart of an example method 1000 of training a network. Method 1000 may be arranged in accordance with at least one embodiment described in the disclosure. Method 1000 may be performed, in some embodiments, by a device or system, such as system 200 (see FIG. 2), classifier 300 (see FIG. 3), classifier 400 (see FIG. 4), classifier 500 (see FIG. 5), classifier 600 (see FIG. 6), classifier 700 (see FIG. 7), system 800 (FIG. 8), system 900 (FIG. 9), or another device or system. Although illustrated as discrete blocks, various blocks may be divided into additional blocks, combined into fewer blocks, or eliminated, depending on the desired implementation.

Method 1000 may begin at block 1002, wherein first data may be generated via a backbone of classifier responsive to receipt of a first (e.g., personal attribute recognition (PAR)) dataset, and method 1000 may proceed to block 1004. For example, with reference to FIG. 4, the first dataset may include PAR dataset 408 and the first data may be data related to feature extraction performed by the backbone 402 of classifier 400.

At block 1004, a first loss function may be calculated via a first (e.g., PAR) classification head of the classifier responsive to the first data, and method 1000 may proceed to block 1006. For example, with reference to FIG. 4, classification head 404 may calculate a PAR loss function (i.e., based on extracted features of the PAR dataset).

At block 1006, the backbone and the first classification head may be trained based on the first loss function. For example, with reference to FIG. 4, backbone 402 and PAR classification head 404 may be trained based on the PAR loss function.

At block 1008, second data may be generated via the backbone responsive to receipt of a second (e.g., personal protection equipment (PPE)) dataset, and method 1000 may proceed to block 1010. For example, with reference to FIG. 4, the second dataset may include PPE dataset 410 and the second data may be data related to feature extraction performed by the backbone 402 of classifier 400.

At block 1010, a second loss function may be calculated via a second (e.g., PPE) classification head of the classifier responsive to the second data, and method 1000 may proceed to block 1014. For example, with reference to FIG. 4, classification head 406 may calculate a PPE loss function (i.e., based on extracted features of the PPE dataset).

At block 1014, the backbone and the second classification head may be trained based on the second loss function. For example, with reference to FIG. 4, backbone 402 and classification head 406 may be trained based on the PPE loss function.

Modifications, additions, or omissions may be made to method 1000 without departing from the scope of the present disclosure. For example, the operations of method 1000 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment. For example, method 1000 may include one or more acts wherein the PAR loss function may be combined with the PPE loss function to generate a prediction. As another example, method 1000 may include one or more acts wherein either the PAR classification head or the PPE classification head may be removed, and the classifier may be deployed. In yet another example, method 1000 may include one or more acts wherein an image is received at the backbone and a prediction is generated based on at least one of the trained first (e.g., PAR) classification head or the trained second (e.g., PPE) classification head.

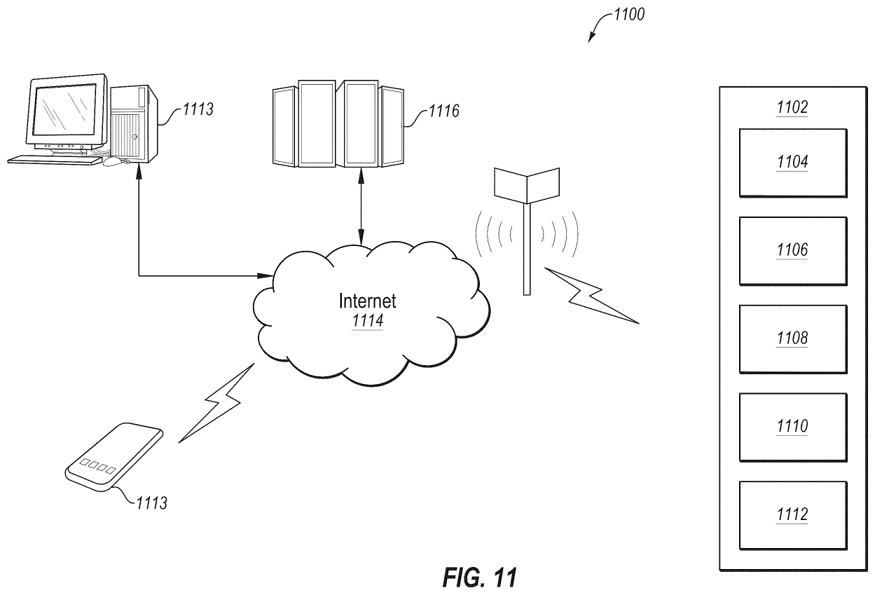

FIG. 11 illustrates a system 1100, according to one or more embodiments of the disclosure. System 100, which may include a security and/or surveillance system, includes a unit 1102, which may also be referred to herein as a “mobile unit,” a “mobile security unit,” a “mobile surveillance unit,” a “physical unit,” or some variation thereof. According to various embodiments, unit 1102 may include one or more sensors 1104 (e.g., cameras, weather sensors, motion sensors, noise sensors, chemical sensors, without limitation) and one or more output devices 1106 (e.g., lights, speakers, electronic displays, without limitation). For example only, sensors 1104 may include one or more cameras, such as thermal cameras, infrared cameras, optical cameras, PTZ cameras, bi-spectrum cameras, any other camera, or any combination thereof. Further, for example only, output devices 1106 may include one or more lights (e.g., flood lights, strobe lights (e.g., LED strobe lights), and/or other lights), one or more speakers (e.g., loudspeakers, two-way public address (PA) speaker systems, or any other suitable speaker), any other suitable output device (e.g., a digital display), or any combination thereof.

In some embodiments, unit 1102 may also include one or more storage devices 1108. Storage device 1108, which may include any suitable storage device (e.g., a memory card, hard drive, a digital video recorder (DVR)/network video recorder (NVR), internal flash media, a network attached storage device, or any other suitable electronic storage device), may be configured for receiving and storing data (e.g., video, images, and/or i-frames) captured by sensors 1104. In some embodiments, during operation, storage device 1108 may continuously record data (e.g., video, images, i-frames, and/or other data) captured by one or more sensors 1104 (e.g., cameras, lidar, radar, RF sensors, environmental sensors, acoustic sensors, without limitation) of unit 1102 (e.g., 24 hours a day, 7 days a week, or any other time scenario).

Unit 1102 may further include a computer 1110, which may include memory and/or any suitable processor, controller, logic, and/or other processor-based device known in the art. Computer 1110 may include an operating system (e.g., installed on a hard drive). Moreover, although not shown in FIG. 11, unit 1102 may include one or more additional devices including, but not limited to, one or more microphones, one or more solar panels, one or more power generators (e.g., fuel cell generators), or any combination thereof. According to various embodiments, computer 1110 may include one or more classifiers (e.g., trained and/or to be trained) (e.g., with reference to FIGS. 2-9), as described herein.

Unit 1102 may also include a communication device 1112, which may comprise any suitable and known communication device (e.g., a modem (e.g., a cellular modem, a satellite modem, a Wi-Fi modem, etc.). In some embodiments, communication device 1112 may include one or more radios and/or one or more antennas. As will be appreciated, components of unit 1102 may be suitably coupled via wired connections, wireless connections, or a combination thereof.

System 1100 may further include one or more electronic devices 1113, which may comprise, for example only, a mobile device (e.g., mobile phone, tablet, etc.), a laptop computer, a desktop computer, or any other suitable electronic device including a display. Electronic device 1113 may be accessible to one or more end-users. Additionally, system 1100 may include a server 1116 (e.g., a cloud server), which may be remote from unit 1102. Communication device 1112, electronic devices 1113, and server 1116 may be coupled to one another via the Internet 1114 (e.g., via a cellular connection).

According to various embodiments of the disclosure, unit 1102 may be within a first location (a “camera location” or a “unit location”), and server 1116 may be within a second location, remote from the first location. In addition, each electronic device 1113 may or may not be remote from unit 1102 and/or server 1116. As will be appreciated by a person having ordinary skill in the art, system 1100 may be modular, expandable, and/or scalable.

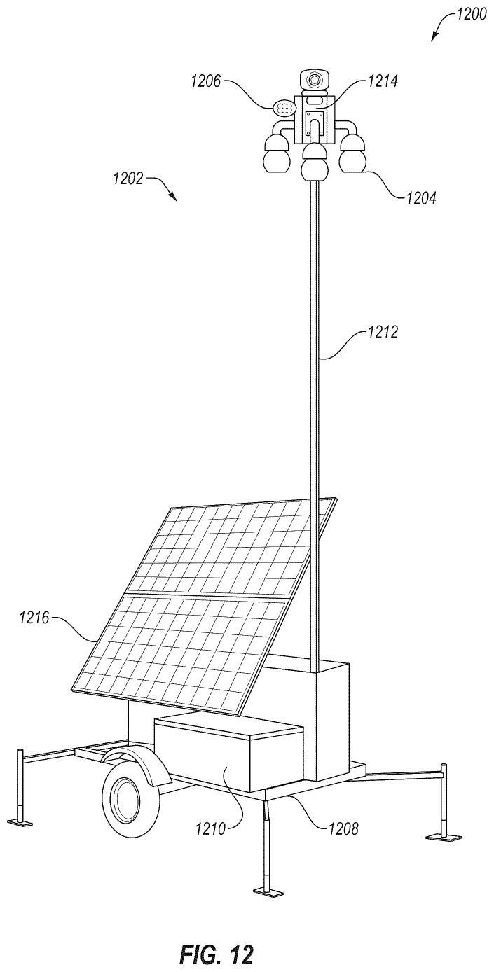

In some embodiments, unit 1102 may include a mobile unit (e.g., a mobile security/surveillance unit). In these and other embodiments, unit 1102 may include a portable trailer (not shown in FIG. 11; see FIG. 12), a storage box (e.g., including one or more batteries) (not shown in FIG. 11; see FIG. 12), and a mast (not shown in FIG. 11; see FIG. 12) coupled to a head unit (e.g., including, for example, one or more cameras, one or more lights, one or more speakers, and/or one or more microphones) (not shown in FIG. 11; see FIG. 12). According to various examples, in addition to sensors and output devices, a head unit of unit 1102 may include and/or be coupled to storage device 1108, computer 1110, and/or communication device 1112.

FIG. 12 depicts another example system 1200 including a unit 1202, in accordance with various embodiments of the disclosure. Unit 1202, which may also be referred to herein as a “mobile unit,” a “mobile security unit,” a “mobile surveillance unit,” or a “physical unit,” may be configured to be positioned in an environment (e.g., a parking lot, a roadside location, a construction zone, a concert venue, a sporting venue, a school campus, without limitation). In some embodiments, unit 1202 may include one or more sensors 1204 (e.g., cameras, weather sensors, motion sensors, noise sensors, without limitation) and one or more output devices 1206 (e.g., lights, speakers, electronic displays, without limitation). Unit 1202 may also include at least one storage device (e.g., internal flash media, a network attached storage device, or any other suitable electronic storage device), which may be configured for receiving and storing data (e.g., video, images, audio, without limitation) captured by one or more sensors of unit 1202. According to some embodiments, unit 1202 may include unit 1102 of FIG. 11, including one or more classifiers (e.g., trained and/or to be trained) (e.g., with reference to FIGS. 2-9), as described herein.

In some embodiments, unit 1202 may include a mobile unit. In these and other embodiments, unit 1202 may include a portable trailer 1208, a storage box 1210, and a mast 1212 coupled to a head unit (also referred to herein as a “live unit,” an “edge device,” or simply an “edge”) 1214, which may include (or be coupled to) for example, one or more batteries, one or more cameras, one or more lights, one or more speakers, one or more microphones, and/or other input and/or output devices. According to some embodiments, a first end of mast 1212 may be proximate storage box 1210 and a second, opposite end of mast 1212 may be proximate, and possibly adjacent, head unit 1214. More specifically, in some embodiments, head unit 1214 may be coupled to mast 1212 an end opposite an end of mast 1212 proximate storage box 1210.

In some examples, unit 1202 may include one or more primary batteries (e.g., within storage box 1210) and one or more secondary batteries (e.g., within head unit 1214). In these embodiments, a primary battery positioned in storage box 1210 may be coupled to a load and/or a secondary battery positioned within head unit 1214 via, for example, a cord reel.

In some embodiments, unit 1202 may also include one or more solar panels 1216, which may provide power to one or more batteries of unit 1202. More specifically, according to some embodiments, one or more solar panels 1216 may provide power to a primary battery within storage box 1210. Although not illustrated in FIG. 12, unit 1202 may include one or more other power sources, such as one or more generators (e.g., fuel cell generators) (e.g., in addition to or instead of solar panels). As will be appreciated, unit 1202 may include one or controllers (e.g., within head unit 1214) including one or more operating systems, which may be configured and/or updated in accordance with various embodiments disclosed herein.

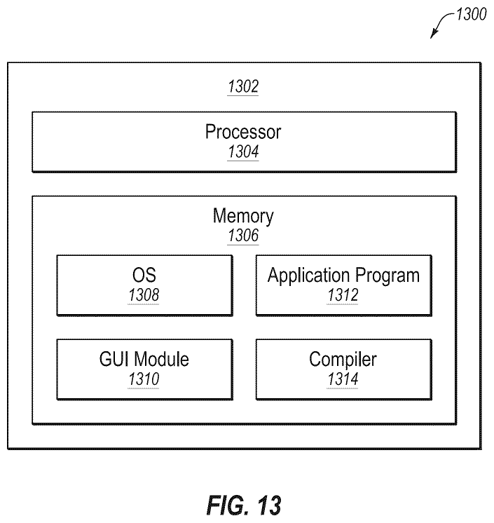

FIG. 13 illustrates a system 1300 that may be used to implement embodiments of the disclosure. System 1300 may include a computer 1302 that comprises a processor 1304 and memory 1306. For example only, and not by way of limitation, computer 1302 may include a workstation, a laptop, or a hand-held device such as a cell phone or a personal digital assistant (PDA), a server (e.g., server 1116), computer 1110 (see FIG. 1), or any other processor-based device known in the art. In one embodiment, computer 1302 may be operably coupled to a display (not shown in FIG. 13), which presents images to the user via a GUI. As will be appreciated, computer 1302 may include one or controllers including one or more operating systems, which may be configured and/or updated in accordance with various embodiments disclosed herein. According to various embodiments, computer 1302 may include one or more classifiers (e.g., trained and/or to be trained) (e.g., with reference to FIGS. 2-9), as described herein.

Generally, computer 1302 may operate under control of an operating system 1108 stored in memory 1306, and interface with a user to accept inputs and commands and to present outputs through a GUI module 1310. Although GUI module 1310 is depicted as a separate module, the instructions performing the GUI functions may be resident or distributed in the operating system 1308, a program 1312, or implemented with special purpose memory and processors. Computer 1302 may also implement a compiler 1314 that allows a program (e.g., code) 1312 written in a programming language to be translated into processor 1304 readable code. After completion, program 1312 may access and manipulate data stored in memory 1306 of computer 1302 using the relationships and logic that are generated using compiler 1314.

Further, operating system 1308 and program 1312 may include instructions that, when read and executed by computer 1302, may cause computer 1302 to perform the steps necessary to implement and/or use various embodiments of the disclosure. Program 1312 and/or operating instructions may also be tangibly embodied in memory 1306 and/or data communications devices, thereby making a computer program product or article of manufacture according to an embodiment of the present disclosure. As such, the term “program” as used herein is intended to encompass a computer program accessible from any computer readable device or media. Program 1312 may exist on an electronic device (e.g., electronic device 1113; see FIG. 11), a server (e.g., server 1116; see FIG. 11), a mobile unit (e.g., mobile unit 1102; see FIG. 11), and/or another device. Furthermore, portions of program 1312 may be distributed such that some of program 1312 may be included on a computer readable media within an electronic device (e.g., electronic device 1113), some of program 1312 may be included on a computer readable media on a server (e.g., server 1116), some of program 1312 may be included on a computer readable media on a surveillance unit (e.g., unit 1102), and/or some of program 1312 may be included on a computer readable media on another device. In some embodiments, program 1312 may be configured to run on electronic device 1113, server 1116, unit 1102, another computing device, or any combination thereof. As a specific example, program 1312 may exist on server 1116 and/or unit 1102 and may be accessible to a user via electronic device 1113.

In accordance with common practice, the various features illustrated in the drawings may not be drawn to scale. The illustrations presented in the disclosure are not meant to be actual views of any particular apparatus (e.g., circuit, device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., circuit, device, or system) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, the term “approximately” or the term “about,” when used in reference to a numerical value for a particular parameter, is inclusive of the numerical value and a degree of variance from the numerical value that one of ordinary skill in the art would understand is within acceptable tolerances for the particular parameter. For example, “about,” in reference to a numerical value, may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed:

1. A system, comprising:
a classifier configured to receive a first dataset and a second, different dataset, the classifier including:
a backbone having a number of layers and configured to generate an output based on at least one of the first dataset or the second, different set;
a first classification head configured to receive the output of the backbone and generate a first loss function; and
a second, different classification head configured to receive the output of the backbone and to generate a second, different loss function.

2. The system of claim 1, further comprising a mobile surveillance unit including the classifier.

3. The system of claim 1, wherein the classifier is configured to train the backbone and the first classification head based on the first loss function.

4. The system of claim 1, wherein the classifier is configured to train the backbone and the second, different classification head based on the second, different loss function.

5. The system of claim 1, wherein the classifier is configured to train the second, different classification head and the first classification head substantially simultaneously.

6. The system of claim 1, wherein the classifier is configured to train the second, different classification head and the first classification head separately during different phases.

7. The system of claim 1, wherein the first dataset comprises a personal attribute recognition (PAR) dataset and the second, different dataset comprises a personal protection equipment (PPE) dataset.

8. A method, comprising:
generating first data via a backbone of classifier responsive to receipt of a first dataset;
calculating a first loss function via a first classification head of the classifier responsive to the first data;
training the first classification head based on the first loss function;
generating second data via the backbone responsive to receipt of a second dataset;
calculating a second loss function via a second classification head of the classifier responsive to the second data; and
training the second classification head based on the second loss function.

9. The method of claim 8, wherein:
generating the first data comprises generating the first data responsive to receive of a personal attribute recognition (PAR) dataset;
calculating the first loss function via the first classification head comprises calculating a PAR loss function via a PAR classification head; and
training the first classification head based on the first loss function comprises training the PAR classification head based on the PAR loss function.

10. The method of claim 9, wherein:
generating the second data comprises generating the second data responsive to receive of a personal protection equipment (PPE) dataset;
calculating the second loss function via the second classification head comprises calculating a PPE loss function via a PPE classification head; and
training the second classification head based on the second loss function comprises training the PPE classification head based on the PPE loss function.

11. The method of claim 8, further comprising combining the first loss function and the second loss function to generate a prediction.

12. The method of claim 8, further comprising one of:
removing the first classification head and deploying the classifier; or
removing the second classification head and deploying the classifier.

13. The method of claim 8, further comprising receiving an image at the backbone and generating a prediction based on at least one of the trained first classification head or the trained second classification head.

14. The method of claim 8, wherein training the second classification head comprises training the second classification head while training the first classification head.

15. The method of claim 8, wherein:
training the second classification head comprises training the second classification head during one phase; and
training the first classification head comprises training the first classification head during another, different phase.

16. A non-transitory computer-readable media having computer instructions stored thereon that, in response to being executed by a processing device of a system, cause the system to perform or control performance of operations comprising:
generate first data responsive to a first dataset;
calculate a first loss function via a first classification head responsive to the first data;
train the first classification head based on the first loss function;
generate second data responsive to receipt of a second dataset;
calculate a second loss function via a second classification head responsive to the second data; and
train the second classification head based on the second loss function.

17. The non-transitory computer-readable media of claim 16, wherein:
training the first classification head comprises training the first classification head during one phase; and
training the second classification head comprises training the second classification head during another, different phase.

18. The non-transitory computer-readable media of claim 16, the operations further comprising generate a prediction based on at least one of the first loss function or the second loss function.

19. The non-transitory computer-readable media of claim 16, the operations further comprising:
receiving an image; and
responsive to the image, generating a prediction based on at least one of the trained first classification head or the trained second classification head.

20. The non-transitory computer-readable media of claim 16, wherein training the second classification head comprises training the second classification head while training the first classification head.

21. The non-transitory computer-readable media of claim 16, the operations further comprising:
receiving an image;
detecting an object in the image;
generating a cropped image including the detected object; and
responsive to the cropped image, generating a prediction based on at least one of the trained first classification head or the trained second classification head.

22. A method, comprising:
receiving a first dataset at a classifier;
training a backbone and a first classification head of the classifier based on a first loss function on the first dataset;
receiving a second dataset at the classifier;
training the backbone and a second classification head of the classifier based on a second loss function on the second dataset; and
generating at least one prediction via at least of the first classification head or the second classification head.

23. The method of claim 22, wherein generating comprises:
generating a first prediction via the first classification head; and
generating a second prediction via the second classification head.

24. The method of claim 23, further comprising combining the first prediction and the second prediction to generate a final prediction.

25. The method of claim 22, wherein generating the at least one prediction comprises generating a final prediction via the second classification head.
